(19) United States
(12) Patent Application Publication
(10) Pub. No.: US 2016/0098730 A1
(43) Pub. Date: Apr. 7, 2016

(54) System and Method for Block-Chain Verification of Goods

(71) Applicant: The Filing Cabinet, LLC, Stamford, CT (US)

(72) Inventor: Patrick Joseph Feeney, Stamford, CT (US)

(21) Appl. No.: 14/504,356

(22) Filed: Oct. 1, 2014

(51) Int. Cl. G06Q 30/00; G06Q 20/06; G06Q 20/38

(52) U.S. Cl. CPC G06Q 30/0185; G06Q 20/3825; G06Q 20/3829; G06Q 20/065; G06Q 2220/00

(57) ABSTRACT

A method for block-chain verification of goods includes obtaining, by a first computing device, a first address. The method includes exporting, by the first computing device, the first address to a first code affixed to a first product. The method includes filing, by the first computing device, a first crypto-currency transaction to the first address, at a transaction register. The method includes receiving, by a second computing device, from a code scanner, the first address, scanned from the first code affixed to the first product. The method includes verifying, by the second computing device, the first crypto-currency transaction at the transaction register, using the first address. The method includes identifying, by the second computing device, based on the verification, that the first product is authentic.

### TECHNICAL FIELD

This invention relates to inventory tracking More particularly, the present invention relates to methods and apparatus for authenticating inventory to prevent counterfeiting.

### BACKGROUND ART

The spread of counterfeit goods has become global in recent years. According to the Counterfeiting Intelligence Bureau (CIB) of the International Chamber of Commerce (ICC), counterfeit goods make up 5 to 7% of world trade. A report by the Organization for Economic Co-operation and Development (OECD) states that up to $200 billion of international trade could have been for counterfeit and pirated goods in 2005, and around $250 billion in 2007. Other estimates conclude that a more accurate figure is closer to $600 billion lost, since the OECD estimates do not include online sales or goods counterfeited and sold within the same country. The United States faces the most economic impact, as the world's largest consumer nation. The counterfeiting industry is lucrative, and the risks of legal consequences are low. In addition, counterfeiting profits fund other organized criminal activities.

Currently existent anti-counterfeiting measures such as seals of authenticity, micro-printing, holographs, watermarks, human-invisible inks, encrypted micro-particles, and tamper-evident packaging can make counterfeiting more difficult, but largely have failed to hamper the counterfeiting industry. Most of these countermeasures may themselves be counterfeited by more or less sophisticated methods. Moreover, frequently the more difficult a technology is for a counterfeiter to spoof, the costly the technology is to implement. Thus, even when countermeasures succeed in thwarting counterfeiters, the counterfeiters exact an indirect economic toll on honest merchants and manufacturers.

In view of the above, there is a need for a fast, accurate, cost-effective, and robust anti-counterfeiting and inventory tracking system.

### SUMMARY OF THE EMBODIMENTS

In one aspect, a method for block-chain verification of goods includes obtaining, by a first computing device, a first address. The method includes exporting, by the first computing device, the first address to a first code affixed to a first product. The method includes filing, by the first computing device, a first crypto-currency transaction to the first address, at a transaction register. The method includes receiving, by a second computing device, from a code scanner, the first address, scanned from the first code affixed to the first product. The method includes verifying, by the second computing device, the first crypto-currency transaction at the transaction register, using the first address. The method includes identifying, by the second computing device, based on the verification, that the first product is authentic.

In a further embodiment, exporting also includes generating, using a private key associated with a public key ascertainable from the first address, a digital signature containing data relating to the product and exporting the digital signature to the code. In a related embodiment, the data relating to the product includes geographical data. The digital signature is a digital certificate in another embodiment. In a related embodiment, filing the first crypto-currency transaction further includes maintaining, in memory accessible to the first computing device, collection of identifiers of a plurality of transaction registers, selecting a transaction register from the plurality of transaction registers, using a reproducibly ascertainable relationship between the first address and the identifier of the allocated transaction register, and filing the first crypto-currency transaction in the selected transaction register. In another embodiment, the transaction register further includes a block chain. In an additional embodiment, filing the first crypto-currency transaction also involves generating, by the first computing device, a block in the block chain. In still another embodiment, filing the first crypto-currency transaction further involves purchasing, crypto-currency from a third party.

In another embodiment, identifying further involves receiving a digital signature from the first code and verifying the digital signature using a public key ascertainable from the first address. An additional embodiment involves filing, by the first computing device, a second crypto-currency transaction to the first address. Another embodiment also involves acquiring, by the first computing device, a second crypto-currency transaction transferring the output of the first crypto-currency transaction to a second address, recording, by the first computing device, the second crypto-currency transaction in the transaction register, and exporting, by the first computing device, the second address to a second code affixed to the first product. Yet another embodiment also involves trading, by the first computing device, a public key and private key associated with the first address as crypto-currency.

Another embodiment involves receiving, by the second computing device, from a code scanner, data including a second address, obtained from a second code affixed to a second product, determining, by the second computing device, that the data is problematic, and identifying, by the second computing device, the second product as inauthentic. In another embodiment, determining further includes determining that the address is not associated with a transaction in the transaction register. In an additional embodiment, determining further involves determining that the address is associated with an out-of-date transaction in the transaction register. In still another embodiment, determining also includes determining that the address is associated with a transaction on an invalid block chain. In a further embodiment, determining also involves determining that the address is associated with a transaction involving a different party from a party currently possessing the second product. In a further embodiment still, determining also involves determining that a digital signature included in the data does not match information regarding the second product. A further embodiment involves alerting, by the second computing device, a user that the second product is counterfeit.

In another aspect, a method for block-chain verification of goods includes scanning, by a computing device, using a code scanner, an address from a code affixed to a product. The method includes verifying, by the second computing device, that the address is associated with a crypto-currency transaction recorded at a transaction register. The method includes determining, based on the verification, that the product is authentic.

In another aspect, system for block-chain verification of goods includes a first computing device, configured to obtain an address, to file a crypto-currency transaction to the address in a transaction register, and to export the address to a code affixed to a product, a code scanner, and a second computing device, configured to receive, from the code scanner, the address, scanned from the code affixed to the product using a code scanner, to verify the crypto-currency transaction at the transaction register, using the address, and to identify based on the verification, that the product is not counterfeit.

In a related embodiment, the second computing device is incorporated in an inventory tracking system. In another related embodiment, the first computing device is incorporated in an inventory tracking system.

These and other features of the present invention will be presented in more detail in the following detailed description of the invention and the associated figures.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1A is a schematic diagram depicting an example of an computing device as described herein;

FIG. 1B is a schematic diagram of a network-based platform, as disclosed herein;

FIG. 2 is a block diagram of an embodiment of the disclosed system;

FIG. 3 is a flow diagram illustrating one embodiment of the disclosed method;

FIG. 4 is a flow diagram illustrating one embodiment of the disclosed method;

FIG. 5 is a flow diagram illustrating one embodiment of the disclosed method.

### DETAILED DESCRIPTION OF SPECIFIC EMBODIMENTS

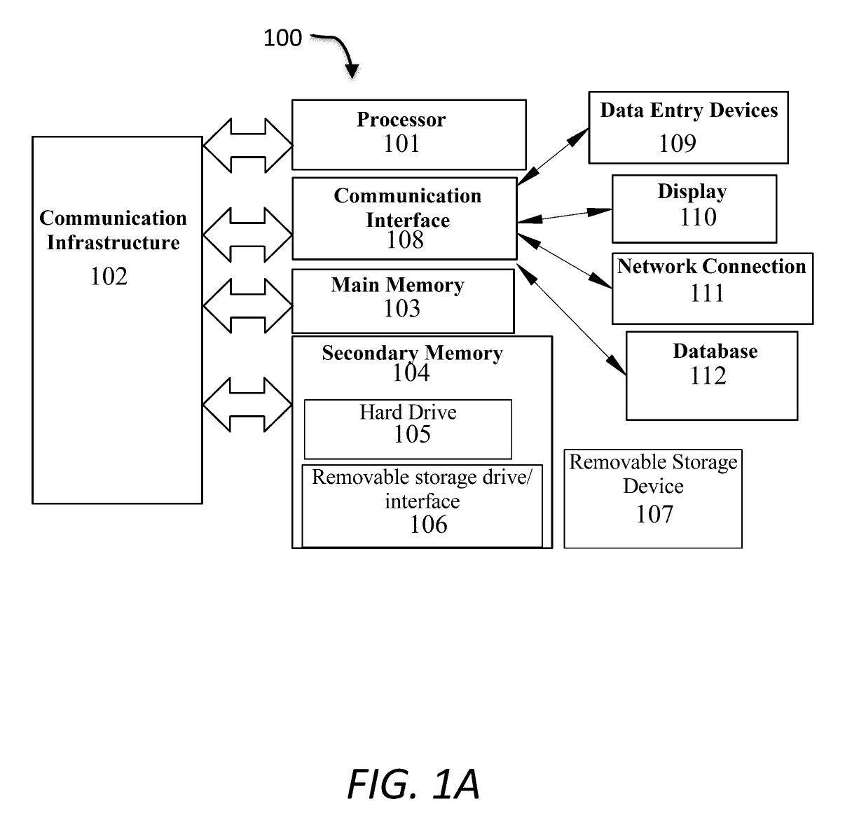

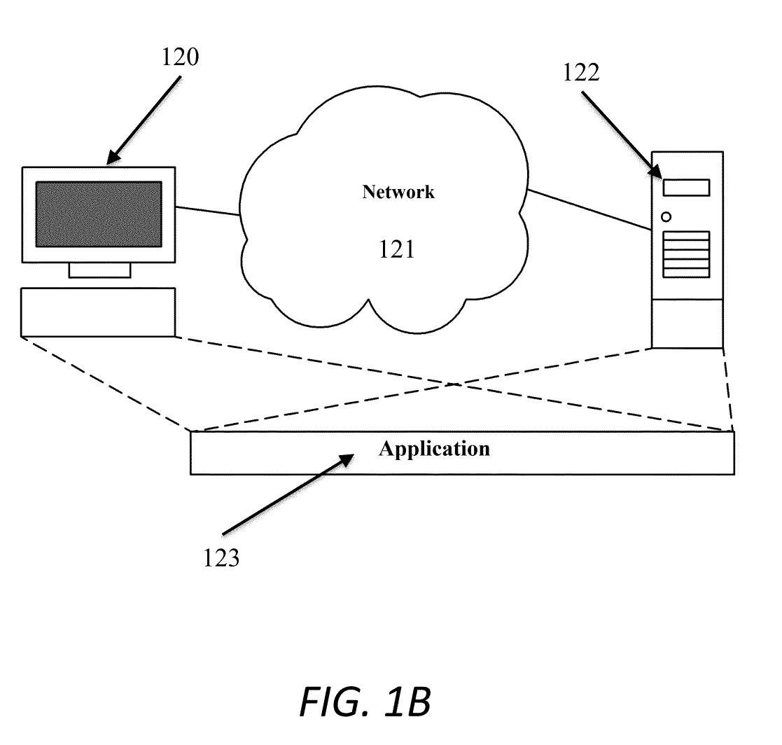

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers. A code scanner coupled to a computing device is a device that can extract information from a “code” attached to an object. In one embodiment, a code contains data concerning the object to which it is attached that may be extracted automatically by a scanner; for instance, a code may be a bar code whose data may be extracted using a laser scanner. A code may include a quick-read (QR) code whose data may be extracted by a digital scanner or camera. A code may include a radio frequency identification (RFID) tag; the code may include an active RFID tag. The code may include a passive RFID tag. A computing device 100 may also be coupled to a code exporter; in an embodiment, a code exporter is a device that can put data into a code. For instance, where the code is a two-dimensional image printed on paper or another object, the code exporter may be a printer. Where the code is a non-writable RFID tag, the code exporter may be a device that can produce a non-writable RFID tag. Where the code is a writable RFID tag, the code exporter may be an RFID writer; the code exporter may also be a code scanner, in some embodiments.

In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The computing device 100 may employ one or more security measures to protect the computing device 100 or its data. For instance, the computing device 100 may protect data using a cryptographic system. In one embodiment, a cryptographic system is a system that converts data from a first form, known as “plaintext,” which is intelligible when viewed in its intended format, into a second form, known as “cyphertext,” which is not intelligible when viewed in the same way. The cyphertext is may be unintelligible in any format unless first converted back to plaintext. In one embodiment, the process of converting plaintext into cyphertext is known as “encryption.” The encryption process may involve the use of a datum, known as an “encryption key,” to alter the plaintext. The cryptographic system may also convert cyphertext back into plaintext, which is a process known as “decryption.” The decryption process may involve the use of a datum, known as a “decryption key,” to return the cyphertext to its original plaintext form. In embodiments of cryptographic systems that are “symmetric,” the decryption key is essentially the same as the encryption key: possession of either key makes it possible to deduce the other key quickly without further secret knowledge. The encryption and decryption keys in symmetric cryptographic systems may be kept secret, and shared only with persons or entities that the user of the cryptographic system wishes to be able to decrypt the cyphertext. One example of a symmetric cryptographic system is the Advanced Encryption Standard (“AES”), which arranges plaintext into matrices and then modifies the matrices through repeated permutations and arithmetic operations with an encryption key.

In embodiments of cryptographic systems that are “asymmetric,” either the encryption or decryption key cannot be readily deduced without additional secret knowledge, even given the possession of the corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which the encryption key involves the use of numbers that are products of very large prime numbers, but the decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

The one or more client devices 120 and the one or more servers 122 may communicate using any protocol according to which data may be transmitted from the client 120 to the server 122 and vice versa. As a non-limiting example, the client 120 and server 122 may exchange data using the Internet protocol suite, which includes the transfer control protocol (TCP) and the Internet Protocol (IP), and is sometimes referred to as TCP/IP. In some embodiments, the client and server 122 encrypt data prior to exchanging the data, using a cryptographic system as described above. In one embodiment, the client 120 and server 122 exchange the data using public key cryptography; for instance, the client and the server 122 may each generate a public and private key, exchange public keys, and encrypt the data using each others' public keys while decrypting it using each others' private keys.

In some embodiments, the client 120 authenticates the server 122 or vice-versa using digital certificates. In one embodiment, a digital certificate is a file that conveys information and links the conveyed information to a “certificate authority” that is the issuer of a public key in a public key cryptographic system. The certificate in some embodiments contains data conveying the certificate authority's authorization for the recipient to perform a task. The authorization may be the authorization to access a given datum. The authorization may be the authorization to access a given process. In some embodiments, the certificate may identify the certificate authority.

The linking may be performed by the formation of a digital signature. In one embodiment, a digital signature is an encrypted a mathematical representation of a file using the private key of a public key cryptographic system. The signature may be verified by decrypting the encrypted mathematical representation using the corresponding public key and comparing the decrypted representation to a purported match that was not encrypted; if the signature protocol is well-designed and implemented correctly, this means the ability to create the digital signature is equivalent to possession of the private decryption key. Likewise, if the mathematical representation of the file is well-designed and implemented correctly, any alteration of the file will result in a mismatch with the digital signature; the mathematical representation may be produced using an alteration-sensitive, reliably reproducible algorithm, such as a hashing algorithm. A mathematical representation to which the signature may be compared may be included with the signature, for verification purposes; in other embodiments, the algorithm used to produce the mathematical representation is publically available, permitting the easy reproduction of the mathematical representation corresponding to any file. In some embodiments, a third party known as a certificate authority is available to verify that the possessor of the private key is a particular entity; thus, if the certificate authority may be trusted, and the private key has not been stolen, the ability of a entity to produce a digital signature confirms the identity of the entity, and links the file to the entity in a verifiable way. The digital signature may be incorporated in a digital certificate, which is a document authenticating the entity possessing the private key by authority of the issuing certificate authority, and signed with a digital signature created with that private key and a mathematical representation of the remainder of the certificate. In other embodiments, the digital signature is verified by comparing the digital signature to one known to have been created by the entity that purportedly signed the digital signature; for instance, if the public key that decrypts the known signature also decrypts the digital signature, the digital signature may be considered verified. The digital signature may also be used to verify that the file has not been altered since the formation of the digital signature.

The server 122 and client 120 may communicate using a security combining public key encryption, private key encryption, and digital certificates. For instance, the client 120 may authenticate the server 122 using a digital certificate provided by the server 122. The server 122 may authenticate the client 120 using a digital certificate provided by the client 120. After successful authentication, the device that received the digital certificate possesses a public key that corresponds to the private key of the device providing the digital certificate; the device that performed the authentication may then use the public key to convey a secret to the device that issued the certificate. The secret may be used as the basis to set up private key cryptographic communication between the client 120 and the server 122; for instance, the secret may be a private key for a private key cryptographic system. The secret may be a datum from which the private key may be derived. The client 120 and server 122 may then uses that private key cryptographic system to exchange information until the in which they are communicating ends. In some embodiments, this handshake and secure communication protocol is implemented using the secure sockets layer (SSL) protocol. In other embodiments, the protocol is implemented using the transport layer security (TLS) protocol. The server 122 and client 120 may communicate using hyper-text transfer protocol secure (HTTPS).

Embodiments of the disclosed system and methods allow manufacturers, merchants, and consumers to verify the authenticity of goods quickly and accurately. By relying on an open and verifiable registration of goods, the system and methods provide an easy and cost-effective way to produce and verify codes authenticating products. The use of public-key digital signature technology makes the verification robust and reliable.

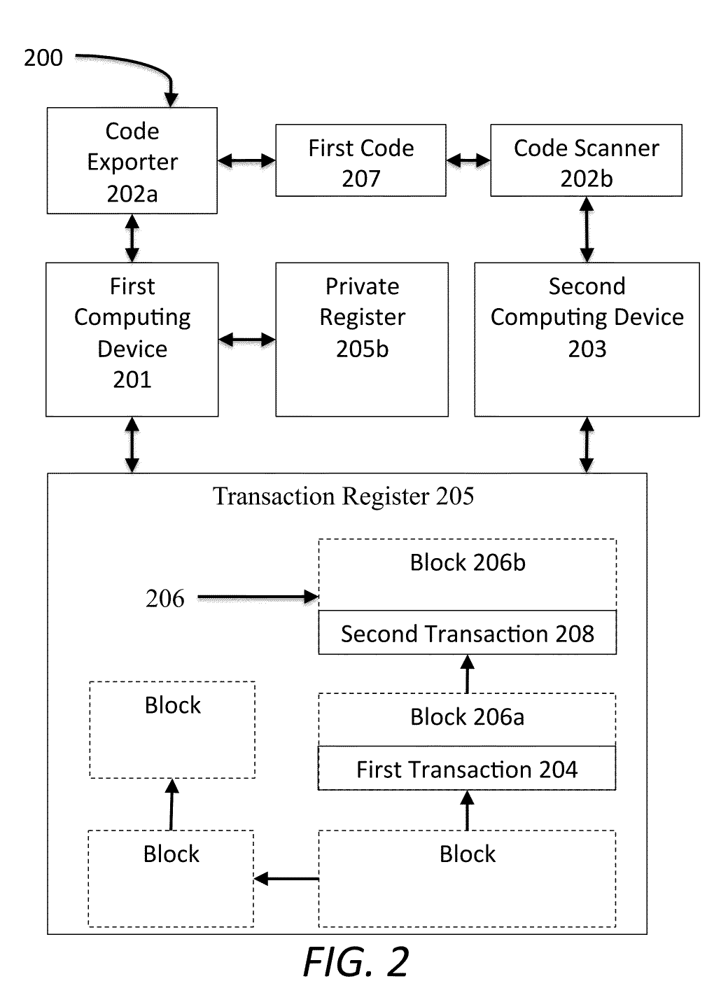

FIG. 2 illustrates an embodiment of a system 200 for block-chain verification of goods. As a brief overview, the system 200 includes a first computing device 201. The system includes a code scanner 202b. The system 200 includes a second computing device 203.

Referring to FIG. 2 in further detail, the system 200 includes a first computing device 201. In some embodiments, the computing device 201 is a computing device 100 as disclosed above in reference to FIG. 1A. In other embodiments, the computing device 201 is a set of computing devices 100, as discussed above in reference to FIG. 1A, working in concert; for example, the computing device 201 may be a set of computing devices in a parallel computing arrangement. The computing device 201 may be a set of computing devices 100 coordinating their efforts over a private network, such as a local network or a virtual private network (VPN). The computing device 201 may be a set of computing devices 100 coordinating the efforts over a public network, such as the Internet. The division of tasks between computing devices 100 in such a set of computing devices working in concert may be a parallel division of tasks or a temporal division of tasks; as an example, several computing devices 100 may be working in parallel on components of the same tasks at the same time, where as in other situations one computing device 100 may perform one task then send the results to a second computing device 100 to perform a second task. In one embodiment, the computing device 201 is a server 122 as disclosed above in reference to FIG. 1B. The computing device 201 may communicate with one or more additional servers 122. The computing device 201 and the one or more additional servers 122 may coordinate their processing to emulate the activity of a single server 122 as described above in reference to FIG. 1B. The computing device 201 and the one or more additional servers 122 may divide tasks up heterogeneously between devices; for instance, the computing device 201 may delegate the tasks of one component to an additional server 122. In some embodiments, the computing device 201 functions as a client device 120 as disclosed above in reference to FIG. 1B.

In some embodiments, the first computing device 201 is configured to obtain an address, and to file a crypto-currency transaction 204 to the address in at least one transaction register 205a. In one embodiment, a transaction register is a register that records a set of public keys, from a public key cryptographic system as described above in reference to FIGS. 1A-1B, and a list of valid crypto-currency transactions transferring some transferable item, such as value, property, virtual currency, title, or other right, responsibility, or relationship associated with one or more of the listed public keys. In one embodiment, a crypto-currency transaction 204 is a collection of textual data stating that the owner of a certain transferable item represented in the transaction register is transferring that item to the owner of an address, along with a digital signature created using the private key associated with the owner's public key, as described above in reference to FIGS. 1A-1B. For instance, the crypto-currency transaction may describe a transfer of virtual currency, such as crypto-currency as described below. The crypto-currency transaction may describe the transfer of a right to a service. The crypto-currency transaction may describe the transfer of a physical good; for instance, crypto-currency transaction may describe the sale of a product. Likewise, the crypto-currency transaction may describe the transfer of responsibility concerning a product; for instance, a first crypto-currency transaction may memorialize the moment when a shipping company becomes responsible for a product the shipping company is transporting to a merchant, and a second crypto-currency transaction may memorialize the merchant becoming responsible for the product upon acknowledging receipt. In some embodiments, a transfer nominally of one item may be used to represent a transfer of another item; for instance, a transfer of virtual currency may be interpreted by the system 200 as representing the moment that a product changes owners; conversely, where the item nominally transferred is something other than virtual currency, the transfer itself may still be treated transfer of virtual currency, having value that depends on many potential factors including the value of the item nominally transferred and the monetary value attendant to having the output of the transfer moved into a particular user's control.

In one embodiment, an address is a textual datum identifying the recipient of virtual currency in a crypto-currency transaction 204. In some embodiments, the address is linked to a public key, the corresponding private key of which is owned by the recipient of the transfer of virtual currency. For instance, the address may be the public key. The address may be a representation, such as a hash, of the public key. The address may be linked to the public key in the memory of a computing device. Where the address is linked to a public key, the transferee in the crypto-currency transaction 204 may record a subsequent transaction transferring some or all of the virtual currency to a new address in the same manner.

In some embodiments, the at least one transaction register 205a includes a data storage facility controlled by a trusted party. The data storage facility may include a database 112 as described above in reference to FIGS. 1A-1B. The data storage facility may include a data structure such as a hash table that permits rapid lookup of data stored in the data storage facility. The trusted party may be a proprietor of the system 200. The trusted party may be a third-party entity, such as an entity maintaining data centers for services such as cloud-computing services. In other embodiments the at least one transaction register 205a may include several data storage facilities maintained by one or more trusted parties; for instance, the at least one transaction register 205a may include several data storage facilities, to which crypto-currency transactions 204 are directed as set forth in further detail below. The data storage facilities may be on the same machine. The data storage facilities may be on the same server. The data storage facilities may be in different servers, but in the same data center. The data storage facilities may be in various data centers. The at least one transaction register 205a may be several transaction registers 205a to which crypto-currency transactions 204 are directed as set forth in further detail below.

In some embodiments, the at least one transaction register 205a includes a block chain 206. In one embodiment, the block chain 206 is a transaction register 205a that records one or more new crypto-currency transactions 204 in a data item known as a block 206a-b. The blocks 206a-b may be created in a way that places the blocks 206a-b in chronological order, and links each block 206b to a previous block 206a in the chronological order, so that any computing device may traverse the blocks 206a-b in reverse chronological order to verify any crypto-currency transactions 204 listed in the block chain 206. As a non-limiting example, each new block 206b may be required to contain a cryptographic hash describing the previous block 206a. In some embodiments, the block chain 206 contains a single first block, known as a “genesis block.”

The creation of a new block 206b may be computationally expensive; for instance, the creation of a new block 206b may be designed by a protocol accepted by all participants in forming the block chain 206 to take a powerful set of computing devices a certain period of time to produce. Where one block 206a takes less time for a given set of computing devices to produce the block 206a, the protocol may adjust the algorithm to produce the next block 206b so that it will require more steps; where one block 206a takes more time for a given set of computing devices to produce the block 206a, protocol may adjust the algorithm to produce the next block 206b so that it will require fewer steps. As an example, the protocol may require a new block 206b to contain a cryptographic hash describing its contents; the cryptographic hash may be required to satisfy a mathematical condition, achieved by having the block 206b contain a number, called a nonce, whose value is determined after the fact by the discovery of the hash that satisfies the mathematical condition. Continuing the example, the protocol may be able to adjust the mathematical condition so that the discovery of the hash describing a block and satisfying the mathematical condition requires more or less steps, depending on the outcome of the previous hashing attempt. The mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, the production of a new block 206b according to the protocol is known as “mining.”

In some embodiments, the protocol also creates an incentive to mine new blocks. The incentive may be financial; for instance, successfully mining a new block 206b may result in the person or entity that mines the block 206b receiving a predetermined amount of currency. The currency may be fiat currency. The currency may be crypto-currency as defined below. In other embodiments, the incentive may be redeemed for particular products or services; the incentive may be a gift certificate with a particular business, for instance. In some embodiments, the incentive is sufficiently attractive to cause participants to compete for the incentive by trying to race each other to the creation of blocks. Each block 206b created in the block chain 206 may contain a record or transaction describing one or more addresses that receive an incentive, such as virtual currency, as the result of successfully mining the block 206b.

Where two entities simultaneously create new blocks, the block chain 206 may develop a fork; the protocol may determine which of the two alternate branches in the fork is the valid new portion of the block chain 206 by evaluating, after a certain amount of time has passed, which branch is longer. “Length” may be measured according to the number of blocks in the branch. Length may be measured according to the total computational cost of producing the branch. The protocol may treat only crypto-currency transactions 204 contained the valid branch as valid crypto-currency transactions 204. When a branch is found invalid according to this protocol, crypto-currency transactions 204 registered in that branch may be recreated in a new block in the valid branch; the protocol may reject “double spending” crypto-currency transactions 204 that transfer the same virtual currency that another crypto-currency transaction 204 in the valid branch has already transferred. As a result, in some embodiments the creation of fraudulent crypto-currency transactions 204 requires the creation of a longer block chain branch by the entity attempting the fraudulent crypto-currency transaction 204 than the branch being produced by the rest of the participants; as long as the entity creating the fraudulent crypto-currency transaction 204 is likely the only one with the incentive to create the branch containing the fraudulent crypto-currency transaction 204, the computational cost of the creation of that branch may be practically infeasible, guaranteeing the validity of all crypto-currency transactions 204 in the block chain 206. In some embodiments, where the algorithm producing the blocks 206a-b involves a cryptographic hash using a well-designed hashing algorithm, attempts to avoid the computational work necessary to create the hashes by simply inserting a fraudulent transaction in a previously created block may be thwarted by the “avalanche effect,” whereby a small alteration of any data within the block chain causes the output of the block chain to change drastically; this means that alterations are readily detectable to any person wishing to validate the hash of the attempted fraudulent block.

In another embodiment, the transaction register 205a is an alternative chain. In one embodiment, an alternative chain is one or more blocks (not shown) that are incorporated into a blockchain 206, by including at least one hash representing data in the alternative chain in at least one block in the blockchain 206 that is mined; where the mathematical puzzle involved in creating the new block is the production of a new hash, the additional hash in the block may not affect the degree of difficulty, and thus miners are not put at a computational disadvantage incorporating the alternative chain. The alternative chain may be incorporated using one or more merkle trees (not shown). The merkel tree may a structure containing a hash of each datum in the alternative chain as leaf notes, with each internal node containing a hash of all of its child nodes; thus, by the avalanche principle, the root of a merkle tree may be a hash that recursively represents all the data hashed in the merkle tree, and thus a set of data in the alternative chain, so that incorporation of the root in a block in the blockchain 206 amounts to incorporation of the data from the alternative chain that the merkle tree represents. A miner may charge a fee for incorporating the alternative chain in a block the miner mines. In an embodiment, verification of a transaction filed in the alternative chain involves first locating the transaction in the alternative chain, verifying its digital signature, and verifying each hash between that location and the blockchain block (for instance by verifying each hash in the merkle tree from the leaf corresponding to the transaction to the root), verifying the hash of the block incorporating the alternative chain, and then verifying the block up the block chain as described above.

In some embodiments, the virtual currency is traded as a crypto-currency. In one embodiment, a crypto-currency is a digital, currency such as Bitcoins, Peercoins, Namecoins, and Litecoins. The crypto-currency may be decentralized, with no particular entity controlling it; the integrity of the crypto-currency may be maintained by adherence by its participants to established protocols for exchange and for production of new currency, which may be enforced by software implementing the crypto-currency. The crypto-currency may be centralized, with its protocols enforced or hosted by a particular entity. In lieu of a centrally controlling authority, such as a national bank, to manage currency values, the number of units of a particular crypto-currency may be limited; the rate at which units of crypto-currency enter the market may be managed by a mutually agreed-upon process, such as creating new units of currency when mathematical puzzles are solved, the degree of difficulty of the puzzles being adjustable to control the rate at which new units enter the market. The mathematical puzzles may be the same as the algorithms used to make productions of blocks in a block chain 206 computationally challenging; the incentive for producing blocks may include the grant of new crypto-currency to the miners. Quantities of crypto-currency may be exchanged using crypto-currency transactions 204 as described above in reference to FIG. 2.

In some embodiments, the owner of crypto-currency keeps his or her currencies in a crypto-currency wallet, which is defined as any facility that stores crypto-currency. The storage of crypto-currency may be the storage of the public and private keys associated with crypto-currency received by the owner. In some embodiments, the user stores the crypto-currency in a virtual wallet, which is located at what amounts to a “crypto-currency bank”; the virtual wallets are exchanges and firms that are located through the Internet. The virtual wallets may accept fiat as payment and provide the user with crypto-currency or other chosen crypto-currencies to hold within their virtual account. In other embodiments, the user keeps crypto-currency in a local wallet, which is a storage device (i.e. hard drive, memory device) that the user can physically move and store in any manner he or she wants. If a user with a local wallet wants to use his or her crypto-currency the user must hook it back up to a computer device that has wallet software on it and then he or she can move the crypto-currency around. In other embodiments, the user keeps crypto-currency in a physical wallet that stores one or more addresses associated with the crypto-currency in physical form, in addition to the corresponding private keys permitting expenditure as described below, such as a paper wallet in which a user prints out his or her crypto-currency from his or her local wallet storage device or his or her virtual wallet. A paper wallet may be a piece of paper with one or more QR codes on it that, once scanned, can be put on a local or virtual wallet or spent by scanning the QR codes right into a point of sale system. A physical wallet may keep the private and public keys associated with crypto-currency in any code readable by a code scanner as described above in reference to FIGS. 1A-1B.

Wallets may have “cold storage” or “hot storage.” Since the rampant hacking and stealing of bitcoin wallets that has been done firms have created “cold storage.” “Cold storage” is storage of one's crypto-currency in a location that is not connected to the Internet and sometimes is not even located where virtual wallets are kept. Virtual wallets refer to “hot storage” or “hot wallet” as a term that their contents are exposed to hackers via the virtual wallets. These “hot wallets” are full of coins being used. References to hot and cold wallets are now main-stream for wallet companies. The ratio of hot to cold wallets is usually 10% or 20% hot and 80% to 90% cold. The transfer either virtually or physically back and forth between the wallets internally to have security confidence. In the end, all kinds of crypto-currency wallets may be place to store private and public keys, confirmed by the block chain, but equate to funds or fiat currency.

In some embodiments, the private keys associated with transactions are maintained in a private register 205b. The private register 205b may include a data store or data structure permitting the first computing device 201 to retrieve private keys rapidly. The private register 205b may include a database 112 as described above in reference to FIGS. 1A-B. The private register 205b may include public keys as well; the private register 205b may link the public keys to their corresponding private keys. The private register 205b may include certificates, or information required to create certificates, from one or more certificate authorities that issued private and public keys in the private register 205b; the private register 205b may link certificates or information for creating certificates to the corresponding private or public keys. Persons skilled in the art will be aware of many ways to link one datum to a related datum; for instance, a private key, its corresponding public key, and information identifying an issuing certificate authority may be three cells in a database row in a database included in the private register 205b, so that retrieval of the row using a query specifying any of the three, or a set of data containing any of the three, will produce the other two. The private register 205b may contain additional data; for instance, the private register 205b may contain records describing transactions involving each private or public key, information identifying the entities involved in the transactions, or information identifying the address to which the transactions were conveyed.

In some embodiments, the first computing device 201 is configured to export the address to a first code 207 affixed to a product. The system 200 may include a code exporter 202a coupled to the first computing device 201; the code exporter 202a may be any code exporter as described above in reference to FIGS. 1A-1B. The first code 207 may be a code as described above in reference to FIGS. 1A-1B. In one embodiment a product may be any tangible or intangible thing that may be exchanged for value, excluding the first transaction 204; in other words, the value for which the product is exchanged is unrelated to the value of the virtual currency exchanged to produce the first transaction 204. The product may be a good, such as an article of manufacture or an item produced in agriculture. The product may be merchandise. The product may be a consumable. The product may be a fixed asset. The product may be a circulating tool. The product may be a library books. The product may be capital equipment. The product may be a bill of fiat currency. The product may be commercial paper. The product may be an item, such as a coupon or voucher, which may be used as proof of payment for a service. For instance, the product may be a ticket for conveyance on a transportation carrier such as a train, bus, or airline. The product may be a ticket for an entertainment event such as a sporting event or a concert. The product may combine other anti-counterfeiting measures with the first code 207.

In some embodiments, the first code 207 is incorporated in an inventory control system (not shown). In one embodiment, an inventory control system is a system for managing and locating objects or materials. Modern inventory control systems may rely upon codes, such as barcodes or (RFID) tags, to provide automatic identification of products. To record an inventory transaction, the inventory control system may use a code scanner to automatically identify the product, and then may collects additional information from operators via fixed terminals (workstations), or mobile computers. The code used in the inventory control system may be matched to a data structure mapping codes to data concerning products, such as a database 112 as described above in reference to FIGS. 1A-1B. The data structure mapping codes to products may be the transaction register 205a. The data structure mapping codes to products may be separate from the transaction register 205a. The party managing the inventory control system may be the party managing the system 200. The party managing the inventory control system may be a separate party. Inventory control systems may also include antitheft devices; for instance, goods in a retail store may have RFID tags affixed to them that RFID readers can detect leaving the premises, setting off alarms. In some embodiments, the incorporation of the first code 207 into an inventory tracking system helps to prevent common inventory tracking errors; for instance, verification as described below can automatically catch the application of the inventory tracking code to an incorrect product, if the first code 207 is incorporated in the inventory tracking code or if the first code 207 shares a label with the inventory tracking code. The first computing device 201 may be incorporated in an inventory tracking system.

Some embodiments of the system include a second computing device 203. In some embodiments, the second computing device 203 is a computing device 100 as disclosed above in reference to FIG. 1A. The second computing device may be any combination of computing device 100 as described above for the first computing device 201, in reference to FIG. 2. The second computing device 203 may be the first computing device 201. The second computing device 203 may be a portion of the inventory control system of a merchant. The second computing device 203 may be a part of a payment processing system, such as one or more cash registers or a system linked to one or more cash registers, operated by a merchant. The second computing device 203 may be a device belonging to a consumer. The second computing device 203 may be coupled to at least one code scanner 202b. In some embodiments, the second computing device 203 is configured to receive, from the code scanner, the address, scanned from the code affixed to the product using a code scanner, to verify the crypto-currency transaction at the block, using the address, and to identify based on the verification, that the product is authentic, as set forth in further detail below.

Some embodiments of the system 200 include a self-destruct device (not shown) incorporated with the code in the product. The self-destruct device may be designed to damage the product; for instance, the self-destruct device may burn out circuits in an electronic product. The self-destruct device may release dye that permanently stains the product. In other embodiments, the self-destruct device damages the code 207. For example, the self-destruct device may erase the memory of the code 207, where the code 207 has a writable memory. The self-destruct device may stain the surface of a printed code, such as a QR code, rendering it illegible for code scanners. In some embodiments, the self-destruct device is designed to communicate with the first computing device 201 by any means described above in reference to FIGS. 1A-2; for instance, the self-destruct device may be designed to perform near-field communication with any network-enabled device, which may relay messages to or from the first computing device 201. Thus, for instance, upon scanning the code 207 in an inventory control system, the first computing device 201 may discover the product to which the code was appended was stolen, and signal the self-destruct device, via the inventory control system, to activate, damaging the product, code, or both.

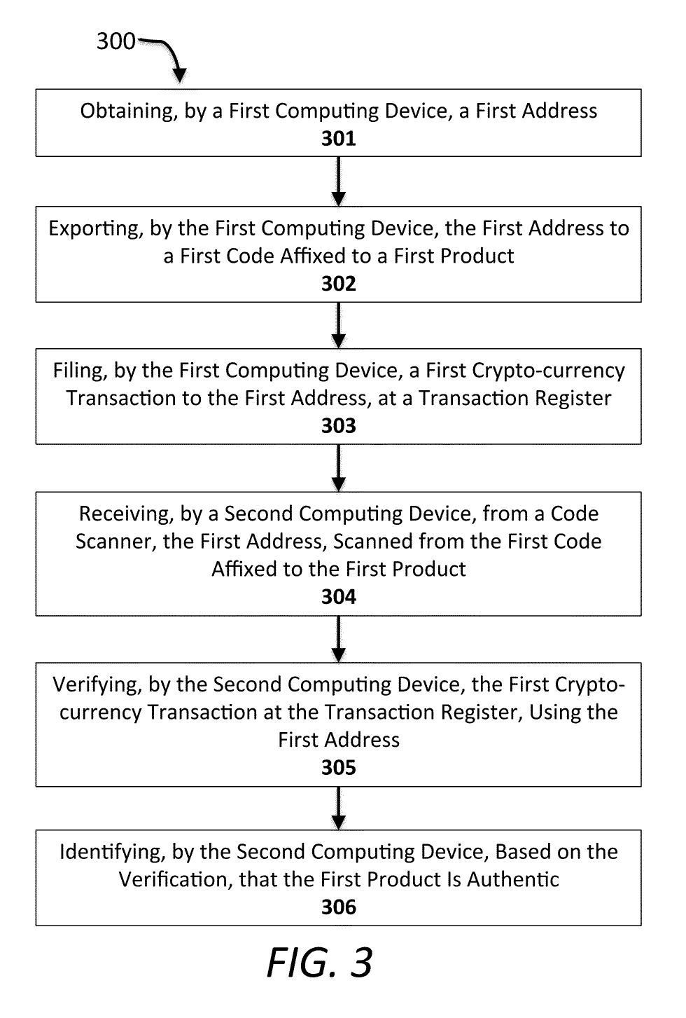

FIG. 3 illustrates some embodiments of a method 300 for block-chain verification of goods. The method 300 includes obtaining, by a first computing device, a first address (301). The method 300 includes exporting, by the first computing device, the first address to a first code affixed to a first product (302). The method 300 includes filing, by the first computing device, a first crypto-currency transaction to the first address, at a transaction register (303). The method 300 includes receiving, by a second computing device, from a code scanner, the first address, scanned from the first code affixed to the first product (304). The method 300 includes verifying, by the second computing device, the first crypto-currency transaction at the transaction register, using the first address (305). The method 300 includes identifying, by the second computing device, based on the verification, that the first product is authentic (306).

Referring to FIG. 3 in greater detail, and by reference to FIG. 2, the first computing device 201 obtains a first address (301). In some embodiments, obtaining the first address includes obtaining a public key; obtaining may include obtaining the corresponding private key as well. The first computing device 201 may generate the public key and private key. In other embodiments, the public key and private key are issued by a certificate authority. Obtaining the address may also include generating an address using the public key. For instance, the address may be a cryptographic hash produced by hashing the public key. In other embodiments, the address is not obtained from the public key, but is linked to the public key by a data structure; for instance, the address may be linked to the public key in a database. The database may be available to the public on a read-only basis. The database may be available only to privileged users or devices.

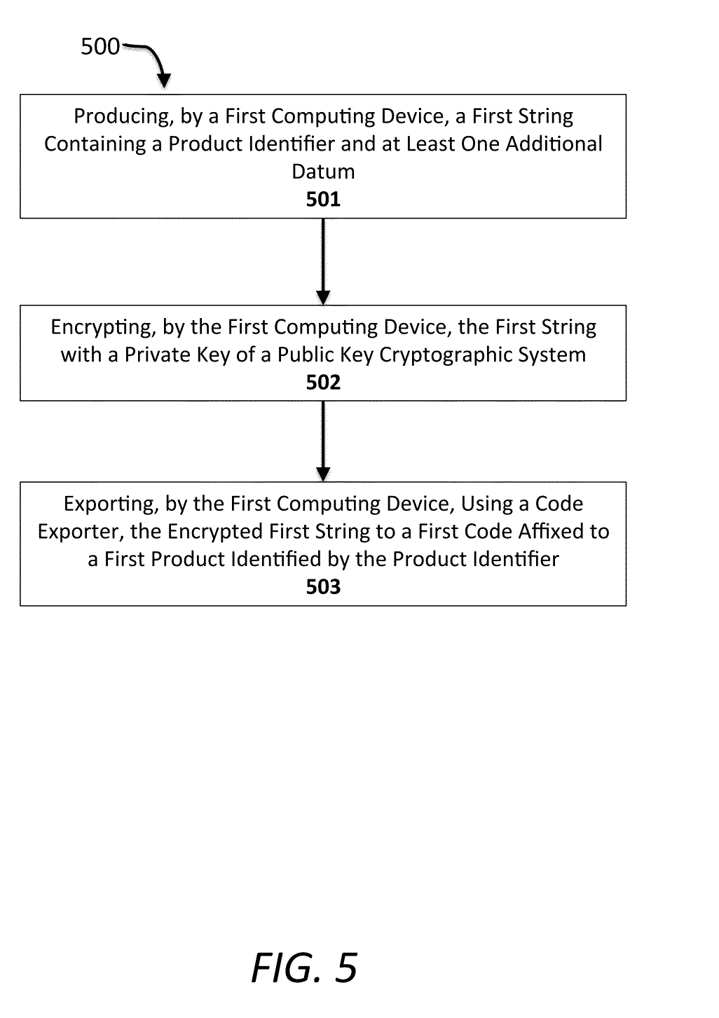

The first computing device 201 exports the first address to a first code 207 affixed to a first product (302). The first computing device 201 may use a code exporter 202a to export the first address to the first code 207. The first computing device 201 may print out a QR code containing the first address. The first computing device 201 may print out a bar code containing the first address. The first computing device 201 may print out a non-writable RFID tag containing the first address. The first computing device 201 may export the first address to a writeable RFID tag. The first computing device 201 may convey the first address to another device, such as a computing device operated by a merchant receiving the product, which in turn produces the first code 207; the computing device operated by the merchant may be a part of the merchant's inventory control system. In some embodiments, the first computing device 201 also generates a digital signature containing data relating to the product, using a private key associated with a public key ascertainable from the first address. The digital signature may be generated as described above in relation to FIGS. 1A-1B. The data relating to the product may include data identifying the product. The data relating to the product may include data identifying the merchant. The data relating to the product may include geographical data; for instance, the geographical data may describe a location of a merchant that has ordered the product. The geographical data may include a retail location where the product is scheduled to be sold. Where the first code 207 is printed or encoded by a computing device belonging to the merchant, the merchant may convey to the first computing device 201 the location where the first code 207 is being printed, and the first computing device 201 sends the merchant a digital signature containing that location data. The first computing device 201 may export the digital signature to the first code 207. The digital signature may include a digital certificate; where the address corresponds to a public key produced by certificate authority, the digital certificate may also be produced with that certificate authority. The digital signature may include a string containing a product identifier and an additional datum, as described below in reference to FIG. 5. In other embodiments, the digital signature is created using the private key that is used to sign the first crypto-currency transaction, as set forth in further detail below.

In some embodiments, the first computing device 201 exports the first address to the first code 207 via an inventory tracking system; for instance, the first computing device 201 may provide the first address to one or more machines administered by a client that is a merchant, shipper, or warehouse operator; the one or more machines may provide the first address to the client's inventory tracking system. The inventory tracking system may use the first address as a tracking number to identify the first product. The inventory tracking system may link the first address to the tracking number used to identify the first product. Scanning the first code 207 using the inventory tracking system scanners may enable the inventory tracking system simultaneously to authenticate the first product and to initiate sale or price checks of the first product. In other embodiments, the inventory tracking system uses a separate code to identify the first product for the purposes of inventory tracking, while using the first code 207 for authentication. The inventory tracking system may track some products using addresses produced by the system 200 and others using more conventional inventory tracking codes.

The first code 207 may contain the private key corresponding to a public key associated with the address. The first code 207 may contain a public key associated with the address. The first code 207 may contain the information that enables a computing device that scans the first code 207 to identify the transaction register 205a; the information may be a uniform resource identifier (URI) identifying the transaction register. The information may be a uniform resource locator (URL) identifying the transaction register 205a. The information may include information necessary to determine the reproducibly ascertainable relationship between the transaction register 205a and the first address.

The first code 207 is affixed to a first product. In some embodiments, the first code 207 is attached to the product; the first code 207 may be adhered to the first product. The first code 207 may be printed on the first product. The first code 207 may be incorporated in the first product; for instance, the first code 207 may be incorporated in a coating deposited on the exterior of the product, such as a glaze on a ceramic. The first code 207 may be incorporated in a tag sewn on the first product. The first code 207 may be created with the pigmentation of the surface of the product, by whatever means any pattern of pigmentation is created on the exterior of the product. The first code 207 may be embedded within the product; for instance, the first code 207 may be an RFID tag concealed within the product. The first code 207 may be stamped on the product. The first code 207 may be carved out of the product; for instance, the first code 207 may be etched in the product, using lasers or cutting tools. The first code 207 may be created as a part of the manufacturing process producing the first product. As an example, if a component of the first product is produced by additive manufacturing process such as three-dimensional printing, the process may produce a surface detail of the component incorporating the first code 207. If a component of the product is created via a reductive process, such as machining, the first code 207 may be created as a surface detail during the reductive process. If a component of the first product is produced by molding, the molding process may produce the first code 207 as a surface detail of the component. Where the first code 207 is produced on the surface of a component of the first product, additional layers may be added over the first code 207, for example by lamination. The first code can hide in a chip, for instance, a chip of identification containing the code may be inserted into an animal. A self-destruct device may also be affixed to the product. The self-destruct device may be incorporated in the first code 207

The first computing device 201 files a first crypto-currency transaction 204 to the first address, at a transaction register 205a (303). In some embodiments, the first computing device 201 selects one transaction register 205a from a plurality of transaction registers. For instance, the first computing device 201 may maintain, in memory accessible to the first computing device 201, collection of identifiers of a plurality of transaction registers, select a transaction register 205a from the plurality of transaction registers, using a reproducibly ascertainable relationship between the first address and the identifier of the allocated transaction register 205a, and file the first crypto-currency transaction 204 in the selected transaction register 205a. The reproducibly ascertainable relationship may be a record in a data structure linking the first address and the identifier of the allocated transaction register 205a. The reproducibly ascertainable relationship may be a mathematical relationship between the address and the identifier of the allocated transaction register; for instance, the reproducibly ascertainable relationship may be a mathematical algorithm or function mapping a numerical space containing addresses to a numerical space containing the identifiers of transaction registers 205a. By selecting the transaction register 205a from a plurality of transaction registers, the first computing device 201 may make the verification described below faster; for instance, block-chain verification may be faster on one of a plurality of short block chains rather than a single long block chain, given a fast and invariant way to map a given address to a given block chain.

In some embodiments, the transaction register 205a includes a block chain 206. The first computing device 201 may file the first crypto-currency transaction by generating, by the first computing device, a block in the block chain, as described above in relation to FIG. 2. The first computing device 201 may then use the block to generate many transactions 204 by selling itself small fractions of the virtual currency associated with the block. In another embodiment, the first computing device 201 may file the first crypto-currency transaction by purchasing crypto-currency from a third party. In some embodiments, the third party is a miner who gained a portion of the virtual currency corresponding to a block 206a in the block chain 206. In other embodiments, the third party is any possessor of crypto-currency within a system for exchanging crypto-currency. In some embodiments, the first computing device 201 may purchase one quantity of virtual currency, and then divide that quantity very finely to produce many transactions 204 by means of “purchasing” the virtual currency from itself; thus, the cost per transaction of purchasing the virtual currency may be extremely small. In other embodiments, the first crypto-currency transaction 204 is a crypto-currency transaction purchasing the output of a previous crypto-currency transaction; for instance, an earlier crypto-currency transaction may be purchased by the manufacturer of the first product, and a later transaction may record the transfer of the product from the manufacturer to a subsequent party on a supply chain, such as a shipment company or wholesale distributor, as described more fully below. In some embodiments, the first crypto-currency transaction 204 describes the transfer to which it corresponds; for instance, the first crypto-currency transaction 204 may contain a note stating that it corresponds to the sale of the first product from the manufacturer to a wholesaler, or to the placement of the first product into the care of a shipping company. The first crypto-currency transaction 204 may identify the first product. The first crypto-currency transaction 204 may identify the party from which the first product is being transferred. The first crypto-currency transaction 204 may identify the party to which the first product is being transferred. In some embodiments, the first computing device 201 files the first crypto-currency transaction 204 after exporting the first address to the code 207. In other embodiments, the first computing device 201 files the first crypto-currency transaction 204 after exporting the first address to the code 207.

The method 300 includes receiving, by a second computing device 203, from a code scanner, the first address, scanned from the first code affixed to the first product (304). In one embodiment, the code scanner is incorporated in the inventory control system of a merchant. For instance, the merchant may receive the product from a distributor of products, and scan the first code 207 to verify that the product is authentic, and to verify its supply chain history, as set forth in further detail below. In another embodiment, the code scanner is coupled to a computing device 203 used by a retail customer; for example, where the first code 207 is a QR code, a customer may use a mobile device such as a smartphone or tablet to read the first code 207 via a digital camera coupled to the mobile device, to verify that the product being offered to the customer for sale is authentic, or to verify the manner in which the retail acquired the product. The second computing device 203 may be associated with a scanner operated to authenticate a ticket for transportation or for an entertainment event.

The second computing device 203 verifies the first crypto-currency transaction at the transaction register, using the first address (305). Where the first code 207 includes information identifying the transaction register 205a, the second computing device 203 may use that information to locate the transaction register 205a. Where the transaction register 205a was selected from a plurality of registers according to a reproducibly ascertainable algorithm, the second computing device 203 may use the reproducibly ascertainable algorithm to determine the correct transaction register 205a of the plurality of registers at which to verify the first crypto-currency transaction 204; the second computing device 203 may obtain data describing the reproducibly ascertainable algorithm from the first code 207. In some embodiments, the second computing device 203 checks the first crypto-currency transaction 204 by querying a device that manages the transaction register 205a; for instance, where the first computing device 201 or a third party computing device manages the transaction register, the second computing device 203 may submit a query to the first computing device 201 or the third party computing device. In other embodiments, where the transaction register 205a includes a block chain, the second computing device 203 performs block chain verification; the second computing device 203 may locate one or more block chains 206 containing the first transaction 204. The second computing device 203 may determine that the block chain 206 it has identified is the longest block chain, as discussed above, to determine which of a plurality of transactions is the first transaction 204.

In some embodiments, the second computing device 203 also verifies that the private key used to perform the transaction belongs to the entity that uses the first computer 201. In some embodiments the entity using the first computer 201 provides a way to query the private register 205b; for instance, a web site or mobile application may be provided to the second computer 203 to use in querying the private register 205b. In other embodiments, the first computing device 201 provides a digital certificate that verifies the identity of the entity using the first computing device 201 and links that entity to the private key. The second computer 203 may also confirm that the entity controlling the first computer 201 is the possessor of a public key or linked address, such as the first address; this may be accomplished using a query to the private register 205b or using a digital signature.

In some embodiments, the second computing device 203 checks a series of transactions including the first transaction 205a; as an example, where the first transaction 204 is the latest of a series of transactions tracking a product through its supply chain, as described below, the second computing device 203 may verify the first transaction 204 and all previous transactions. The second computing device 203 may also compare the history presented by all transactions pertaining to the product to a history of transactions provided by the previous participant from whom the operator of the second computing device 203 is considering receiving the product. The second computing device 203 may check each transaction to the first address. The second computing device 203 may check the transactions outputting to each transaction to the first address.

The second computing device 203 identifies that the first product is authentic, based on the verification (306). In an embodiment, the first product is authentic if it is a genuine product offered for sale by an authorized merchant; for instance, a counterfeit product is inauthentic. Likewise, a product that has been stolen, or is otherwise being sold by a merchant who does not have the right to possess the product, is inauthentic. In some embodiments, the second computing device 203 determines that the first transaction 204 is in a series of transactions originating with the manufacturer or producer of the product; for instance, the manufacturer may obtain a transaction as described above in reference to step 302 of FIG. 3, and provide a public proof that the transaction is performed by the manufacturer. Where the address for the manufacturer's transaction is linked to a public key issued by a certificate authority, a digital signature using the corresponding private key may also serve as a digital certificate, as described above in reference to FIGS. 1A-1B; for instance, if the manufacturer files a subsequent crypto-currency transaction to another entity, the digital signature filed by the manufacturer as part of that subsequent transaction may double as a digital certificate.

Where the first transaction 204, or any earlier transaction, identifies the product, the second computing device 203 may verify by comparing the identified product to the one currently proffered by the merchant; the second computing device 203 may provide a description of the identified product to a user of the second computing device 203 so that the user can compare the identified product to the one proffered by the merchant. Likewise, where the first transaction 204, or any earlier transaction, identifies a merchant, the second computing device 203 may verify by comparing the identified merchant to the one currently offering the product; the second computing device 203 may provide a description of the identified merchant to a user of the second computing device 203 so that the user can compare the identified merchant to the one offering the product. In other embodiments, the second computing device 203 receives a digital signature from the first code 207 and verifies the digital signature using a public key ascertainable from the first address. The second computing device 203 may further verify the digital signature by comparing data in the digital signature to known data; for instance, where the digital signature contains geographical data, the second computing device 203 may compare the current location of the first code 207 while scanning to the geographical data.

In some embodiments, the first computing device 201 files a second crypto-currency transaction to the first address. Where the first crypto-currency transaction 204 occurs at a first stage in a supply chain through which the product is moving, the second crypto-currency transaction may occur at a second stage in the supply chain. For instance, the first address may initially be attached to the product in the form of a code, and have no transactions associated with it; the manufacturer may file the first transaction to the first address upon accepting payment from a retailer for the product, or a bulk shipment including the product. A second transaction may be filed to the first address when a consumer purchases the product from the retailer; in some embodiments, the retailer requests the first computing device 201 to perform the second transaction. As an example, the retailer may scan the first code 207 at the point of purchase; the inventory control system of the retailer may query the private register 205b, the transaction register 205a, or both as described above. Continuing the example, the retailer may verify to the first computing device 201 that the retailer is in possession of the first code 207, and has completed the sale of the product. As an example, the retailer may possess a private key corresponding to the first address; for instance, the address may have been chosen, as described above, by creating the address from a public key issued to the retailer by a certificate authority, so that the retailer can send a digital certificate authenticating the retailer; alternatively, the first computing device 201 may send a clerk performing the check out operation a code to be entered upon completing the transaction, such as a personal identification number (PIN). Continuing the example, upon confirmation of a successful purchase, the first computing device 201 may file a second crypto-currency transaction to the first address, indicating that the product has been sold; other information concerning the transaction, such as payment information or the identity of the purchasing customer, may be conveyed to the first computing device 201 as well. In other embodiments, a larger number of crypto-currency transactions to the first address may describe a larger number of intermediate steps along a supply chain. As a result, the repeated transactions may permit the second computing device 203, or the user thereof, to authenticate both the product and the stage in the sales cycle from manufacturing to sales that the product occupies.

In some embodiments, second crypto-currency transaction is reversed; for instance, the user may return the product, and the merchant may wish to revert the state of the product to one reflecting an unsold status. The reversal may involve removing the second crypto-currency transaction from the transaction register 205a. The reversal may involve entering a third crypto-currency transaction transferring the amount, or output, of the second crypto-currency transaction back to the originator of the second crypto-currency transaction. In other embodiments, when the first product is reported stolen, all transactions to the address of the product are recalled, by undoing the transactions. In other embodiments, when the first product is reported stolen, all transactions to the address of the product are reversed, by the entry of a transaction transferring the output of each transaction to that transaction's originating address. In some embodiments, when the first product is reported stolen, the first computing device 201 activates a remote self-destruct mechanism associated with the first code 207.

In some embodiments, the first computing device 201 acquires a second crypto-currency transaction transferring the output of the first crypto-currency transaction to a second address, records the second crypto-currency transaction in the transaction register 205a, and exports the second address to a second code affixed to the first product. As an example, once a party receiving the product in a supply chain has verified that the product is not counterfeit, as described above, the party may accept the product for the party's use in the next link in the supply chain, and request an updated transaction showing that the product has changed hands. The party may provide the first computer 201 with the second address; the party may obtain the second address by any means described above for obtain the first address in reference to step 301 of FIG. 3. The second crypto-currency transaction 208 may be recorded according to any process described above for recording the first crypto-currency transaction 205a, in reference to step 302 of FIG. 3. The first computing device 201 may export the second address to the second code as described above in reference to step 303 of FIG. 3; the first computing device 201 may export the second address by performing the second crypto-currency transaction 208 so that the second computing device 203 can export the second address. In some embodiments, where the first code 207 is writable, the second code may be the same as the first code 207; for instance, the second address may simply be added to the memory of a writable RFID tag that contained the first address, either overwriting the first address or being added in addition to the first address, allowing for a quick offline history check.

Some embodiments combine the use of multiple crypto-currency transactions to the first address, as described above, with one or more transactions from the first address to a second address, as described above, to track the progress of a product through its life cycle. As a non-limiting example, a plurality of components to be incorporated into a product may be tracked as products in their own right; for instance, the hard drive, motherboard, casing, CPU, and other components to be assembled as a computer may each have an affixed code with an address corresponding to the product. Continuing the example, each component may be tracked using transactions to the address of the component, from manufacturing to sales, and from sales to the shipment into a factory where the components are assembled. Further continuing the example, when the components are assembled into a larger item, such as a computer, a code may be affixed to the assembled item containing an address that corresponds to the assembled item; transactions may be recorded from the address of each component to the address of the assembled item. In this example, if a component is later removed from the assembled item, the code of the component may still be traced to the transaction register 205a, which will also show the transaction describing the incorporation of the component into the assembled item. As another example, bulk shipments may be tracked, in bulk, using a single code which contains a series of transactions transferring the output of each previous transaction to an address associated with the next carrier, warehouse, or shipment in the transport and supply operation; each item in the bulk shipment may have a transaction from the address of that item to an address corresponding to the bulk shipment as a whole, so that an item can be traced readily to its bulk shipment, aiding in the discovery of theft or accidental diversion from shipments.

The system 200 may also enable users to continue tracking the movements of components and products through after market sales. For instance, a user may sell one or more hardware components of a computer to another user, and purchase new components. A user who purchases a product may also receive the ability to make future transactions using the code associated with the product; for instance, the user may have the option of receiving a crypto-currency transaction transferring all or some of the output of the first transaction 204 to an address possessed by the user, which the user may export to a code to attach to the product. The user may then file new transactions to addresses associated with later users; as a result, the transfer of the product to each new user may also be authenticated. Continued transactions regarding the product may provide a means whereby even purchasers of used parts can verify the authenticity of the product, further reducing the ability of counterfeiters to profit off of and degrade the brands of genuine manufacturers. Alternatively, the user may be able to request new transactions to the first address, performed by the first computing device 201; the new transactions may reflect additional transfers of ownership of the product. The first computing device 201 may continue to tract ownership of the product by information received along with the new transactions; as in the retail setting, the first computing device 201 may receive additional information identifying new owners of the product.

As an example, the first computing device 201 may maintain a database tracking the state of the first product or of other products after the sale to a consumer. The database may contain user information for the purchasing user; the user may enter user information via a mobile application, an application, or a web browser. The first computing device 201 may collate data concerning the state of products according to current users, creating an inventory of user property for each user. Electronic and physical markets of used goods may likewise use the system 200 to track the status of products; for instance, if the user who purchased the first product wishes to sell the first product via an online auction platform or an online used goods market, the market may use the system 200 to indicate that the item is being offered for sale, by sending a new transaction to the address currently on the first code 207 or by transferring the output of a transaction to the first address to a second address, such as one associated with the online market or auction platform. Likewise, the first computing device 201 may record the subsequent sale of the product via a new transaction as described above. The user may also perform such transactions. Thus, in some embodiments, the first computing device 201 may keep a database describing authenticated after-market goods; users and markets such as physical and online used goods markets may make that database available to further consumers, who may pay a premium for authenticated used goods. In some embodiments, new transactions concerning the first product 201 record the identity of the current user; the current user's identity may also be stored on the first code 207 or a subsequent code. Likewise, the first code 207, a subsequent code, or a transaction may record the current state of the product, as described above in reference to FIG. 3. Users and markets may obtain appraisals of the first product based in part on the state of the product as recorded in the system 207; appraisals themselves can be recorded via transactions or in codes, for future use. Users may utilize the system 200 to record further appraisals of goods; for instance, the user may append a code to a possession of the user, and given an appraisal by a qualified person, who may be registered with the system 200, the user may be able to add the possession to the system as an authenticated product. The user may be able to add an appraised value. In some embodiments, users will use this approach to appraise and inventory some or all personal property, for instance for the purpose of insuring the property and arranging for its inheritance. Each appraisal, note about the state of the property, initial authentication, or other datum concerning any item of property may be recorded as described above in a code, a transaction in the transaction register 205a, a private register 205b, or other database incorporated in the system 200, as described herein in reference to FIG. 3.

Where the system 200 continues to authenticate after-market items, manufacturers may offer programs in which they reacquire such items. For instance, the manufacturer may be inclined to set up a buy-back program for items they want to buy back. The manufacturer can couple the buy-back program with offers to provide trade-in value to apply toward purchase of other products. The manufacturer can offer a manufacturer-sponsored used goods market, analogous to the “certified” used markets commonly offered regarding cars. The manufacturer may offer a “recall and retire” program.

In some embodiments, the first computing device 201 trades a public key and private key associated with the first address as crypto-currency; for instance, if the product is sold to a consumer, the address may cease to be useful for tracking the product, and the first computing device 201 may perform a transaction selling the virtual currency transferred to the address by the first transaction 204 on a crypto-currency market. In some embodiments, every time a new transaction is performed when the product changes hands, the new party acquiring the product pays for the value of the virtual crypto-currency, so that each party on the supply chain, from the manufacturer to the retailer, can recoup the cost of the transactions necessary to perform the disclosed method.

In some embodiments, the second computing device 203 receives data including a second address, obtained from a second code affixed to a second product, by means of a code scanner, determines that the data is problematic, and identifying, by the second computing device, the second product as inauthentic. The second product may be inauthentic if it is counterfeit. The second product may be inauthentic if it is stolen. The second product may be inauthentic if it is presented as being in a stage in the sales cycle that differs from its genuine state; for instance, if the second product is used, but is being presented as new, the second product may be inauthentic. In some embodiments, the second computing device 203 determines that the data is problematic by determining that the second address is not associated with a transaction in the transaction register 205a; for instance, the second code may be a counterfeit code designed to imitate the appearance of the codes used in the system 200. In other embodiments, the second computing device 203 determines that the address is associated with an out-of-date transaction in the transaction register. As an example, a product may have passed from one point to another on the supply chain, with the output of one transaction used as the input of another transaction; a would-be counterfeiter may have obtained a code containing the previous transaction, which is no longer valid for identifying the current state of the product. In another embodiment, the second computing device 203 determines that the address is associated with a transaction on an invalid block chain; for instance, an entity or person in the supply chain may be attempting to create multiple codes to append to counterfeit products by “double spending” as defined above in reference to FIG. 2; in that case, the use of the primary block chain enables the second computing device 203 to identify an invalidly duplicated second code. The second computer 203 may signal to another computing device that all products appended to the invalidly duplicated code may be counterfeit, and should be withdrawn from the market pending further inspection.

In some embodiments, the second computing device 203 determines that the data is problematic by checking it against an inventory tracking system; for instance, the inventory tracking system may describe the second product as being located in a different location, or with a different merchant, than the location at which it was scanned. The inventory tracking system may have the second product recorded as stolen. The inventory tracking system may report that the second product is supposed to be associated with one or more additional products; the lack of the associated products may indicate that a set of components of which the second product was one component, which combined form a single product for sale, have been separated improperly, for instance by a “chop shop” that sells parts of stolen goods.

In other embodiments, the second computing device 203 determines that the address is associated with a transaction involving a different party from a party currently possessing the second product; for instance, the transaction may identify the party that received the product most recently in the supply chain, but that party may not match the party selling the product, indicating a possible theft. In another embodiment, the second computing device 203 determines that a digital signature included in the data does not match information regarding the second product. The digital signature data may indicate a different product from the one being offered by the merchant. The digital signature data may indicate a different geographical location from the one at which the second computer 203 has scanned the second code. The digital signature data may indicate a different merchant from the one currently offering the second product.

In some embodiments, the second computing device 203 alerts a user that the second product is not authentic. In other embodiments, the first computing device 201 alerts a user to the probable inauthenticity of the second product. The second computing device 203 may display the alert to a user of the second computing device; for instance, where the second computing device 203 is a mobile device belonging to a potential consumer or another person, such as a police officer or private investigator, the second computing device 203 may display a message using a display coupled to the second computing device indicating that the second product is inauthentic. The second computing device 203 may use other data output devices, such as audio output devices, to indicate that the second product is inauthentic. In other embodiments, the alert is conveyed to a user of a remote device (not shown); for instance, local law enforcement may receive the alert. The legitimate merchant whose product was reported stolen may receive the alert. In some embodiments, the alert functions as a “silent alarm,” causing the authorities to arrive without warning to apprehend the person or persons offering the inauthentic product for sale. In other embodiments, the alert triggers the activation of a self-destruct device, as described above in reference to FIG. 2.

In some embodiments, the first computing device 201 sends at least one message to the second computing device 203. Where the second computing device 203 belongs to a consumer, the at least one message may identify a product a user of the second computing device 203 may be interested in purchasing; for instance, the first computing device 201 may use past requests from the second computing device 203 to authenticate products. The first computing device 201 may sort the product authentication requests into categories, and determine which categories have the most authentication requests; for instance, the user may frequently authenticate video games, causing the first computing device 201 to propose other video games to the user. The first computing device 201 may describe new product launches. The first computing device 201 may describe discounts or early reviews of products. In other embodiments, the first computing device 201 transmits a message concerning locations that the pattern of authentication checks by the second computing device 203 suggests are frequent shopping locations for the user of the second computing device 203. The at last one message may include without limitation coupons, coupons, sweepstakes, rewards, contests, games, hidden discounts, date and place creation, born on date, product history, and information on who crafted the first product. The at least one message may be stored in the first code 207 or in another code affixed to the first product. The at least one message may be linked to an address, such as the first address, contained in a code affixed to the first product, so that when a second computing device 203 scans the code, the at least one message is provided to the user via the second computing device 203. Where users are registered in the system 200, messages may be sent to the users via any electronic communication, such as text messages or email.

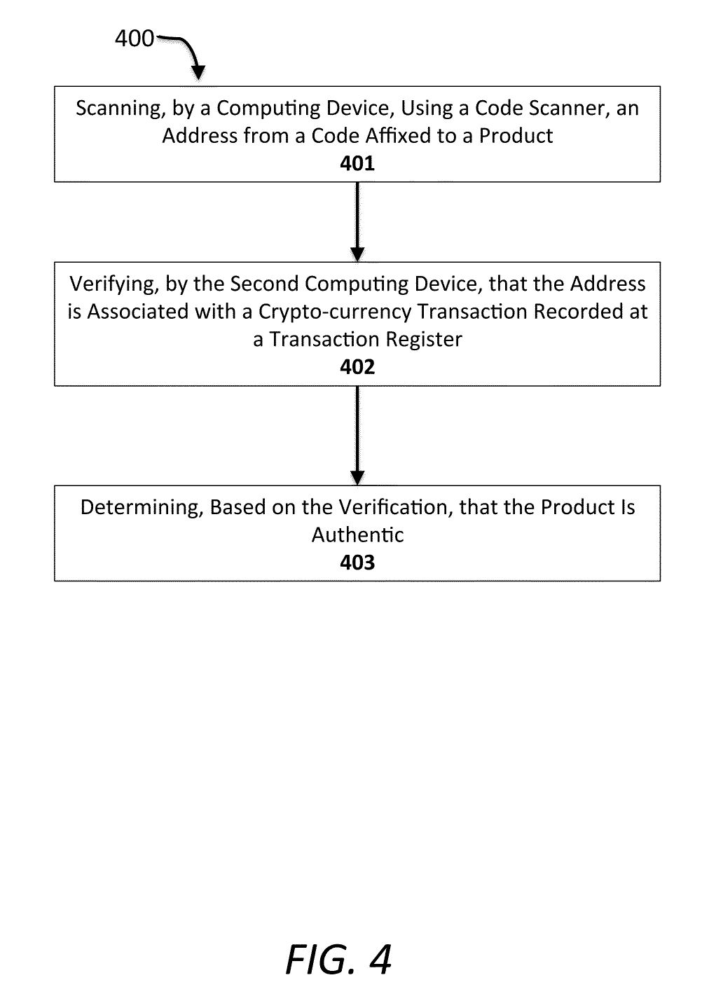

FIG. 4 illustrates some embodiments of a method 400 for block-chain verification of goods. The method 400 includes scanning, by a computing device, using a code scanner, an address from a code affixed to a product (401). The method 400 includes verifying, by the second computing device, that the address is associated with a crypto-currency transaction recorded at a transaction register (402). The method 400 includes determining, based on the verification, that the product is authentic (402).

Referring to FIG. 4 in greater detail, and by reference to FIG. 2, the method 400 includes scanning, by a computing device, using a code scanner, an address from a code affixed to a product (401). In some embodiments, this is implemented as disclosed above in reference to FIG. 3.

The method 400 includes verifying, by the second computing device, that the address is associated with a crypto-currency transaction recorded at a transaction register (402). In some embodiments, this is implemented as disclosed above in reference to FIG. 3.

The method 400 includes determining, based on the verification, that the product is authentic (402). In some embodiments, this is implemented as disclosed above in reference to FIG. 3.

FIG. 5 illustrates some embodiments of a method 500 for product authentication using digital signatures. The method 500 includes producing, by a first computing device, a first string containing a product identifier and at least one additional datum (501). The method 500 includes encrypting, by the first computing device, the first string with a private key of a public key cryptographic system (502). The method 500 includes exporting, by the first computing device, using a code exporter, the encrypted first string to a first code affixed to a first product identified by the product identifier (502).

Referring to FIG. 5 in greater detail, and by reference to FIG. 2, the first computing device 201 produces a first string containing a product identifier and at least one additional datum (501). In one embodiment, the product identifier is a textual datum that identifies the product; the product identifier may be unique to a particular product. The first computing device 201 may store the product identifier in memory accessible to the first computing device 201. The first computing device 201 may store the product identifier in a database 112 as described above in reference to FIGS. 1A-1B. In some embodiments the first computing device 201 stores the product identifier in a private register 205b. In other embodiments, the first computing device 201 stores the product identifier in a transaction register 205a. The product identifier may include an address as describe above in reference to FIGS. 2-3. The first computing device 201 may record at least one crypto-currency transaction to the product identifier, as described above in reference to FIG. 3.

In some embodiments, the string includes at least one additional datum. The at least one additional datum may include a timestamp. The timestamp may include a date. The time stamp may include a time. The timestamp may be a combined datum describing the time and date, such as a Julian Date. The timestamp may correspond to the time that the first product is manufactured. The timestamp may correspond to the time that the first computing device 201 exports to the first code 207 as set forth in further detail below. The timestamp may correspond to a date or time on which the first product is delivered to a merchant; for instance, the timestamp may describe the anticipated time the product will be in stock at the merchant. In other embodiments, the at least one additional datum identifies a merchant. The identification of the merchant may include the name of a person. The identification of the merchant may include the name of a business. The identification of the merchant may include the name of a particular building associated with the merchant, such as a retail branch or stock warehouse. The identification of the merchant may include an identifier used by a jurisdiction to which the merchant is subject to identify the merchant. In additional embodiments, the at least one additional datum identifies a location. The location may include a city. The location may include a state or province. The location may include a county or parish. The location may include a nation. The location may include a territory. The location may include a municipality. The location may include a borough or neighborhood. The location may include a street, square, or block. The location may include a street number or other identifier of a particular building or lot. The location may include a floor, suite, or apartment number identifying a particular place of business or storage within a building or lot. The location may include coordinates, such as the latitude and longitude, or other coordinates used by navigation facilities as described above in reference to FIGS. 1A-1B. The location may be a location where the first product is manufactured. The location may be a location where the first code is affixed to the first product. The location may be a location of a merchant. The at least one additional datum may include a mathematical representation of a digital certificate as described above in reference to FIGS. 1A-1B. The at least one additional datum may include a mathematical representation of other data stored in the first code 207 as described below. The product identifier and the at least one additional datum may be combined using any suitable process for combining textual data into a string; for instance, the product identifier may be concatenated with the at least one additional datum.

The first computing device 201 encrypts the first string with a private key of a public key cryptographic system (502). The public key cryptographic system may be a public key cryptosystem as described above in reference to FIGS. 1A-1B. The public key cryptosystem may be RSA. The public key cryptosystem may be an elliptic curve cryptosystem. The first computing device 201 may generate the private key. The first computing device 201 may generate a public key corresponding to the private key. In other embodiments, the first computing device 201 obtains the private key from a certificate authority as described above in reference to FIGS. 1A-1B. The first computing device 201 may maintain the private key securely in memory accessible to the first computing device 201. The first computing device 201 may publish the public key; for instance, the public key may be available on a website or mobile app generated by the first computing device 201 or another computing device controlled by the entity managing the first computing device 201.

The method 500 includes exporting, by the first computing device 201, using a code exporter, the encrypted first string to a first code 207 affixed to a first product identified by the product identifier (502). The first computing device 201 may export the encrypted product identifier as described above for exporting the first address in reference to FIG. 3. The first product may be any product as described above in reference to FIG. 2. In some embodiments, the first computing device 201 exports to the first code 207 information enabling the discovery of the public key corresponding to the private key; for instance, the first computing device 201 may export the public key to the first code 207. The first computing device 201 may export a network address, such as a URL, where a second computing device 203 can obtain the public key. The URL may correspond to the first computing device 201, or another computing device controlled by the entity operating the first computing device 201. The URL may correspond to a certificate authority issuing the public key. In other embodiments, the first computing device 201 exports to the first code 207 information enabling communication with the first computing device; the information may include a network address, such as a URL, where a second computing device 203 may contact the first computing device 201. In some embodiments the first computing device exports a digital certificate, as described above in reference to FIGS. 1A-1B, to the first code 207. The first code 207 may be affixed to the first product as described above in reference to FIG. 3.

In some embodiments, a second computing device 203 scans the encrypted first string from the first code 207, using a code scanner 205a. This may be implemented as described above in reference to FIG. 3. The second computing device 203 may decrypt the first string, using a public key associated with the private key. The second computing device 203 may obtain the public key from the first code 207. The second computing device 203 may obtain the public key from the first computing device 201. In some embodiments, a mobile application installed on the second computing device 203 periodically obtains public keys from the first computing device 201. In other embodiments, the second computing device 203 queries the first computing device 201 upon scanning the first code 207. In other embodiments, the second computing device 203 obtains information necessary to contact the first computing device 201 from the first code 207; for instance, the second computing device 203 may obtain a network address, such as a URL, from the first code 207. The second computing device 203 may similarly obtain the public key from a third computing device (not shown), such as a server maintained by a certificate authority.

The second computing device 203 may determine, based on the decryption, that the first product is authentic. In some embodiments, a determination of authenticity includes a determination that the product is not counterfeit. The determination of authenticity may include determination that the product was not stolen. Determination of authenticity may involve determining that none of the tests for inauthenticity, described below, result in a conclusion of inauthenticity. In some embodiments, determining authenticity includes determining that the encrypted first string may be decrypted correctly using the public key; for instance, the determination may include verifying that the first string, after decryption, has a required form, such as a product identifier concatenated with at least one additional datum. The first computing device 201 may publish the correct form. Determination of authenticity may include comparing, by the first computing device 201, data in the decrypted first string to additional data. In one embodiment, the second computing device 203 compares a mathematical representation in the first string purporting to represent additional information in the first code 207 to a mathematical representation generated from the additional information in the first code 207. In another embodiment, the second computing device 203 compares additional information in the first code 207 to information concerning the circumstances of the sale of the first product; for instance, the second computing device 203 may compare the location of the first sale to a location recorded in the first code 207, or the second computing device 203 may compare the merchant described in the first code 207 to the merchant offering the first product for sale.

Determination of authenticity may include querying the first computing device 201 using the first string; the first computing device 201 may determine that the product identifier is a valid product identifier, stored in memory accessible to the first computing device 201. The first computing device 201 may determine that the first computing device 201 has received no reports suggesting problems with the first product, such as theft or previous sale. The query may include additional information; for instance, the query may include location information, which the first computing device 201 may compare to location information pertaining to the correct sale of the first product. The query may include merchant information, which the first computing device 201 may compare to merchant information pertaining to the correct sale of the first product.

In some embodiments, the second computing device 203 scans a second string from a second code affixed to a second product, using a code scanner, decrypts the second string using a public key associated with the private key, and determines, based on the decryption, that the second product is not authentic. In some embodiments, the second computing device 203 determines that the second product is not authentic by determining that the decrypted second string is malformed. As described above in reference to FIGS. 1A-1B, as long as the public key cryptographic system has not been broken or rendered obsolete by higher computing power, only possession of the private key will permit the production of a new or modified second string that the public key can decrypt to form a string that is correctly formed, such as a string containing a product identifier concatenated with a particular kind of additional datum. Thus, if the decryption of the second string using the public key produces a decrypted second string that does not have the correct form, or does not contain the correct categories of data, the second computing device 203 may determine that the second string was produced fraudulently or was fraudulently altered by a party not possessing the private key.

In other embodiments, the second computing device 203 determines that the second product is inauthentic by determining that information in the decrypted second string does not match other information concerning the product. In one embodiment, the second computing device 203 determines that the second product is inauthentic by determining that a mathematical representation of data contained in the second code from the decrypted second string does not match corresponding data contained in the second code. In another embodiment, the second computing device 203 determines that the second product is inauthentic by determining that location data from the decrypted second string does not match location data concerning the product. For instance, the second computing device 203 may determine its location when scanning the second code, and that determined location may differ from location data from the decrypted second string; the second computing device 203 may determine its location using a navigation facility as described above in reference to FIGS. 1A-1B. The second computing device 203 may determine its location by receiving location data from a user of the second computing device 203. In other embodiments, the second computing device 203 determines that the second product is inauthentic by determining that merchant data from the decrypted second string does not match merchant data concerning the product. The merchant data concerning the product may be entered by a user. The second computing device 203 may obtain the merchant data concerning the product using location data; for instance, the second computing device 203 may query another computing device concerning the current location of the second computing device 203 and receive data describing a merchant located at that location.

In some embodiments, the second computing device 203 determines that the second product is inauthentic by transmitting a query to the first computing device, using data extracted from the decrypted second string, and receiving, from the first computing device, an indication that the data is problematic. In some embodiments, the indication that the data is problematic includes a report that the second product has been stolen. For instance, an entity that legitimately possessed the second product may discover that the second product was stolen from the entity, and report that the second product was stolen; the entity may include the second string, decrypted or encrypted, in the report. The first computing device 201 may maintain reports that products have been stolen in memory accessible to the first computing device 201. For instance, the first computing device 201 may store the reports in a private register 205b. The first computing device 201 may store the reports in a transaction register 205a. The first computing device may create a new transaction in the transaction register 205a indicating that the theft has taken place, using methods described above in reference to FIG. 3. The indication that the data is problematic may include a report that a product associated with the data has been sold previously; the second computing device 203 may conclude from that report that the second code was stolen or copied from the previously sold product and affixed to the second code, indicating that the second product is likely to be counterfeit.

In other embodiments, the indication that the data is problematic includes location information that does not match a current location of the second product. For instance, the first computing device 201 may store in memory accessible to the first computing device 201 one or more locations where the merchant that is the intended recipient of a product associated with the data is likely to sell the product; the second computing device 203 may convey its current location to the first computing device 201, which may determine that the current location of the second computing device 203 does not match a valid location, indicating that either the second product or the second code has been misappropriated. Alternatively, the first computing device 201 may send the set of valid locations to the second computing device 203, which may perform the comparison. The one or more valid locations may be stored in a private register 205b. The one or more valid locations may be stored in a transaction register 205a; the valid locations may be linked to a crypto-currency transaction as described above in reference to FIG. 3. In other embodiments, the indication that the data is problematic includes merchant information that does not match a merchant offering the product for sale. For instance, the first computing device 201 may store in memory accessible to the first computing device 201 merchant that is the intended recipient of a product associated with the data; the second computing device 203 may convey information describing the merchant currently offering the second product for sale to the first computing device 201, which may determine that the merchant provided by the second computing device 203 does not match the valid merchant, indicating that either the second product or the second code has been misappropriated. Alternatively, the first computing device 201 may send the information concerning the valid merchant to the second computing device 203, which may perform the comparison. The valid merchant may be stored in a private register 205b. The valid merchant may be stored in a transaction register 205a; the valid merchant may be linked to a crypto-currency transaction as described above in reference to FIG. 3.

In some embodiments, the second computing device 203 alerts a user to the probable inauthenticity of the second product. In other embodiments, the first computing device 201 alerts a user to the probable inauthenticity of the second product. The alert may be implemented as described above in reference to FIG. 3.

Although the foregoing systems and methods have been described in some detail for purposes of clarity of understanding, it will be apparent that certain changes and modifications may be practiced within the scope of the appended claims.

1. A method for block-chain verification of goods, the method comprising:
obtaining, by a first computing device, a first address;
exporting, by the first computing device, using a code exporter coupled to the first computing device, the first address to a first code affixed to a first product;
filing, by the first computing device, a first crypto-currency transaction, comprising textual data describing a transfer of a transferable item to the first address and a digital signature signed with a private key of an asymmetric cryptographic system, in a first block in a block chain containing a cryptographic hash of a previously created second block in the block chain;
receiving, by a second computing device, from a code scanner coupled to the second computing device, the first address, scanned from the first code affixed to the first product;
verifying, by the second computing device, the first crypto-currency transaction at the first block, using the first address, by decrypting the digital signature using a public key corresponding to the private key; and
identifying, by the second computing device, based on the verification, that the first product is authentic.

2. A method according to claim 1, wherein exporting further comprises:
generating, using a private key associated with a public key ascertainable from the first address, a digital signature containing data relating to the product; and
exporting the digital signature to the code.

3. A method according to claim 2, wherein the data relating to the product includes geographical data.

4. A method according to claim 2, wherein the digital signature is a digital certificate.

5. A method according to claim 1, wherein identifying further comprises:
receiving a digital signature from the first code; and
verifying the digital signature using a public key ascertainable from the first address.

6. A method according to claim 1, wherein filing the first crypto-currency transaction further comprises:
maintaining, in memory accessible to the first computing device, collection of identifiers of a plurality of block chains;
selecting a block chain from the plurality of block chains, using a reproducibly ascertainable relationship between the first address and the identifier of the allocated transaction register; and
filing the first crypto-currency transaction in the in a block in the selected block chain.

7. (canceled)

8. A method according to claim 7, wherein filing the first crypto-currency transaction further comprises generating, by the first computing device, the second block.

9. A method according to claim 7, wherein filing the first crypto-currency transaction further comprises purchasing crypto-currency from a third party.

10. A method according to claim 1 further comprising filing, by the first computing device, a second crypto-currency transaction to the first address

11. A method according to claim 1, further comprising:
filing, by the first computing device, in the block chain, a second crypto-currency transaction transferring the output of the first crypto-currency transaction to a second address; and
exporting, by the first computing device, the second address to a second code affixed to the first product.

12. A method according to claim 1 further comprising trading, by the first computing device, a public key and private key associated with the first address as crypto-currency.

13. A method according to claim 1 further comprising:
receiving, by the second computing device, from a code scanner, data including a second address, obtained from a second code affixed to a second product;
determining, by the second computing device, that the data is problematic; and
identifying, by the second computing device, the second product as inauthentic.

14. A method according to claim 13, wherein determining further comprises determining that the address is not associated with a transaction in the transaction register.

15. A method according to claim 13, wherein determining further comprises determining that the address is associated with an out-of-date transaction in the transaction register.

16. A method according to claim 13, wherein determining further comprises determining that the address is associated with a transaction on an invalid block chain.

17. A method according to claim 13, wherein determining further comprises determining that the address is associated with a transaction involving a different party from a party currently possessing the second product.

18. A method according to claim 13, wherein determining further comprises determining that a digital signature included in the data does not match information regarding the second product.

19. A method according to claim 13 further comprising alerting, by the second computing device, a user that the second product is counterfeit.

20. A method for block-chain verification of goods, the method comprising:
scanning, by a computing device, using a code scanner, an address from a code affixed to a product;
verifying, by the second computing device, that the address is associated with a crypto-currency transaction recorded at a transaction register; and
determining, based on the verification, that the product is authentic.

21. A system for block-chain verification of goods, the system comprising:
a first computing device, configured to obtain an address, to file a crypto-currency transaction to the address in a transaction register, and to export the address to a first code affixed to a product;
a code scanner; and
a second computing device, configured to receive, from the code scanner, the address, scanned from the code affixed to the product using a code scanner, to verify the crypto-currency transaction at the transaction register, using the address, and to identify based on the verification, that the product is authentic.

22. A system according to claim 21, wherein the second computing device is incorporated in an inventory tracking system.

23. A system according to claim 21, wherein the first computing device is incorporated in an inventory tracking system.
